(19) United States
(12) Patent Application Publication
(10) Pub. No.: US 2005/0198530 A1
(43) Pub. Date: Sep. 8, 2005

(54) Methods and apparatus for adaptive server reprovisioning under security assault

(76) Inventors: David M. Chess, Mohegan Lake, NY (US); Prashant Pandey, Fremont, CA (US); Ian N. Whalley, Pawling, NY (US); Steve R. White, New York, NY (US)

Correspondence Address: Moser, Patterson & Sheridan, Suite 100, 595 Shrewsbury Avenue, Shrewsbury, NJ, 07702, US

(21) Appl. No.: 10/734,802

(22) Filed: Dec. 12, 2003

(51) Int. Cl. G06F 11/30

(52) U.S. Cl. 713/201

(57) ABSTRACT

Methods and apparatus for automated adaptive reprovisioning of servers under security assault. The method comprises detecting a security assault or a possible security assault on a first server, and reprovisioning by automatically creating a new server instance with a desired new server configuration to perform at least one of the tasks performed by said server.

### BACKGROUND OF THE INVENTION

1. Field of the Invention

The present invention generally relates to computers. More specifically, the present invention relates to the field of adaptive server reprovisioning under security assault.

2. Description of the Related Art

Any computer attached to the global Internet will eventually come under electronic assault of one kind or another, by people or programs attempting to take control of it, or attempting to interfere with its normal operations. Even computers within corporate firewalls, not directly coupled to the Internet, often come under assault from attackers who have directly penetrated the firewall, or from computer viruses or Trojan horses that have spread into the company in email or through security holes, and are carrying out automated assaults from within.

When a client computer comes under assault, typically only a single user is impacted, and the affected machine can often be shut down until the attacker gives up or moves on. When a computer functioning as a server comes under assault, many more users may be impacted and the results may be much more significant. If the server belongs to an online merchant and is in the critical path for commerce, that merchant may be unable to conduct business until the server is restored and the attack is fended off. Protecting servers from electronic assault, and minimizing server downtime due to such assault, is a high priority for computer security.

A typical response when a server is attacked or compromised, or when an attack or compromise is strongly suspected, is to bring the server down, or at least disengage it from the network over which the attacker is reaching it. Human experts can then analyze the server and the logs of server activity during the period in question, try to identify the exact nature and origin of the attack, put specific countermeasures in place designed to prevent the attack from recurring, and then (after undoing any damage the attack did to the data on the server) bring the system back up.

While this technique is very effective when it is possible, it requires expert humans to spend significant time in problem detection and elimination, and in many cases it will not be possible to determine the exact nature or origin of the attack. In many real-life cases, the server is simply taken offline for some period of time, and then brought back up, in hopes the attacker will have moved on.

As Information Technology (IT) services become more automated, it is particularly important to find solutions that do not require expert humans to take special action every time a common event (such as a security assault) occurs. The simplest automatic response to an assault, bringing down the suspect system for some period of time and then bringing it up again, is equivalent to the least satisfactory scenario outlined above. It may work in some cases, but in general it only delays the problem; when the attacker (or another attacker exploiting the same vulnerability) returns, the server will have to be taken down again, resulting in more downtime, and eventually skilled humans will have to be called in.

### SUMMARY OF THE INVENTION

In one embodiment according to the present invention, a method of automated adaptive reprovisioning of servers under security assault is provided. The method comprises detecting a security assault or a possible security assault on a first server, and reprovisioning by automatically creating a new server instance with a desired new server configuration to perform at least one of the tasks performed by said first server.

### BRIEF DESCRIPTION OF THE DRAWINGS

The teachings of the present invention can be readily understood by considering the following detailed description in conjunction with the accompanying drawings, in which:

FIG. 1 is a block diagram of the components of a system within which embodiments according to the present invention might be practiced;

FIG. 2 illustrates methods for security monitoring and server reprovisioning in one embodiment according to the present invention;

FIG. 3 illustrates a method for utilizing a sequential reprovisioning operation in one embodiment according to the present invention; and

FIG. 4 illustrates subsystems found in one exemplary computer system that can be used in one embodiment according to the present invention.

To facilitate understanding, identical reference numerals have been used, where possible, to designate identical elements that are common to the figures.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments according to the present invention provide methods and apparatus for adaptive server reprovisioning under security assault. One embodiment comprises an adaptive method of server reprovisioning under security assault, which allows automated IT systems to respond to attacks on servers without requiring skilled human intervention in many cases, without extensive downtime, and also without exposing the systems under attack to repeated assaults targeting the same vulnerability.

As used herein, the term “server” refers to software providing a service, such as a web server or a database server, or the hardware on which that software runs, such as an IBM eServer computer. As used herein, the phrase “new server instance” refers to a new server, running on the same or difference hardware and using the same or different software, playing at least substantially the same role as a prior server. As used herein, a server is judged “likely to be compromised” when sufficient likelihood of compromise is indicated by any of the compromise-detection techniques known to the art. Some embodiments according to the present invention incorporate compromise-detection techniques that produce a numerical probability of compromise, and judge a server likely to be compromised when a certain probability (either fixed in the system, or specifiable by the system administrator or owner) of compromise is met or exceeded. Other embodiments incorporate compromise-detection techniques that operate by detecting certain features typical of known attacks, and judge a server likely to be compromised when one or more of a number of a sets of typical features (either fixed in the system, or specifiable by the system administrator or owner) is detected. Other methods of judging a server likely to be compromised are known to those skilled in the art. This definition also applies to “probable server compromise.”

In one embodiment, when a server is compromised or otherwise sufficiently impacted by an attack, it is taken down, and automatically replaced (taken down) by a new server configuration, that provides the same basic functions as the original server, but is sufficiently different that it is unlikely to be vulnerable to a repeat of the same attack that caused the original server to be taken down. The new server might, for instance, be running different server software, a different operating system, a different version of the network communication stack, a tighter level of encryption or other alternatives. It is contemplated that replacing the server is optional in some embodiments.

In another embodiment, the first time a server is attacked it is taken down and replaced by a server that is slightly different, or even substantially identical. If the server is attacked again, then the server is taken down, where the next replacement that is brought up is significantly different.

It is noteworthy that various intrusion-detection techniques, known in the art, can be implemented to determine if a given server has been subject to assault, rather than innocent exploration.

In another embodiment, an attacked server would in at least some circumstances be replaced by one that provides only a subset of the function of the original. Customers might be able to view existing orders but not create new orders. Documents might be able to be read but not updated, and so on.

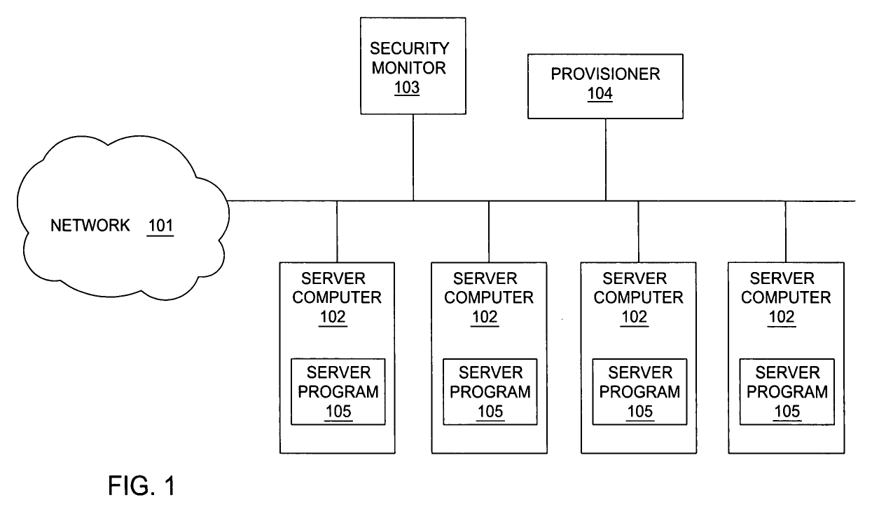

FIGS. 1, 2 and 3 illustrate embodiments according to the present invention. FIG. 1 is a block diagram of the components of a system within which embodiments according to the present invention might be practiced. In FIG. 1, a network 101 allows communication between and among a plurality of server computers 102, each running one or more pieces of server software (programs) 105, a security monitor 103, and a provisioner 104, as well as a plurality of other computers attached to the network 101. The network 101 may be without exclusion the global Internet, or an enterprise intranet, running network protocols such as without exclusion TCP/IP over Ethernet. The server computers 102, security monitor 103 and provisioner 104 may be, for example, IBM eServer xSeries 205's running the Linux operating system, and the server software 105 may be, for example, IBM's WebSphere Application Server. Other possibilities are known to those skilled in the art.

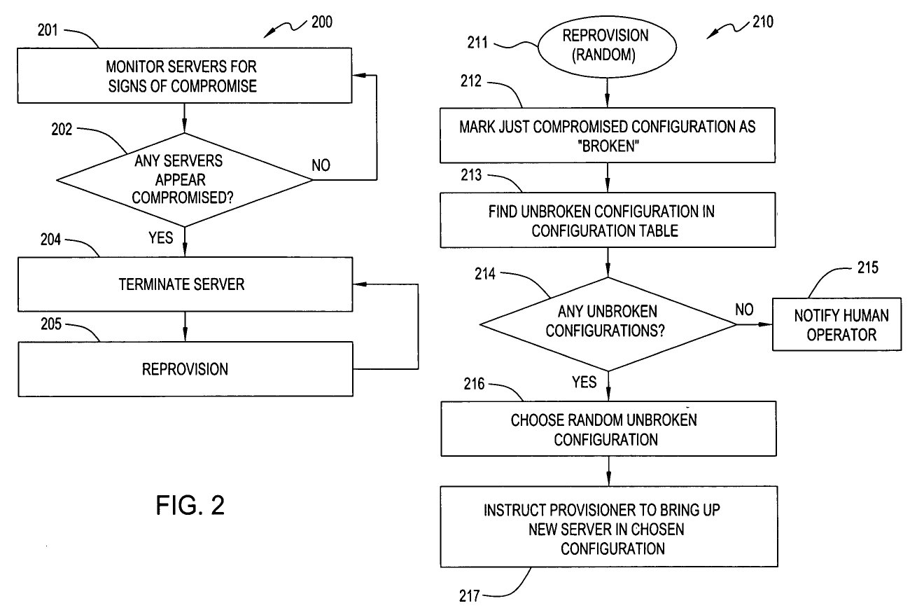

FIG. 2 illustrates a method 200 for security monitoring and a method 210 for reprovisioning in one embodiment according to the invention. The security monitor continually monitors the state of the servers 102 and server programs 105 at block 201. If at block 202 any server is found to exhibit characteristics that make compromise sufficiently probable by heuristic intrusion detection and compromise detection methods known to the art, the security monitor executes a loop. For servers for which compromise seems likely, the security monitor optionally terminates the operation of that server at block 204 and initiates a reprovisioning operation at block 205, as further described herein.

An embodiment of this invention utilizing a random reprovisioning operation begins at block 211. The configuration of the server that was terminated at 204 is marked as “broken” at block 212.

At block 213, the security monitor consults a table of possible configurations, and queries at block 214 to determine if any entries in the table are not marked as “broken.” If there are no such entries, the operation terminates with the notification of a human operator at block 215.

If one or more unbroken configurations are located at 214, one of those configurations is selected at random at block 216. At block 217, the security monitor instructs the provisioner to bring up a new server 102, configured according to the configuration selected at block 216.

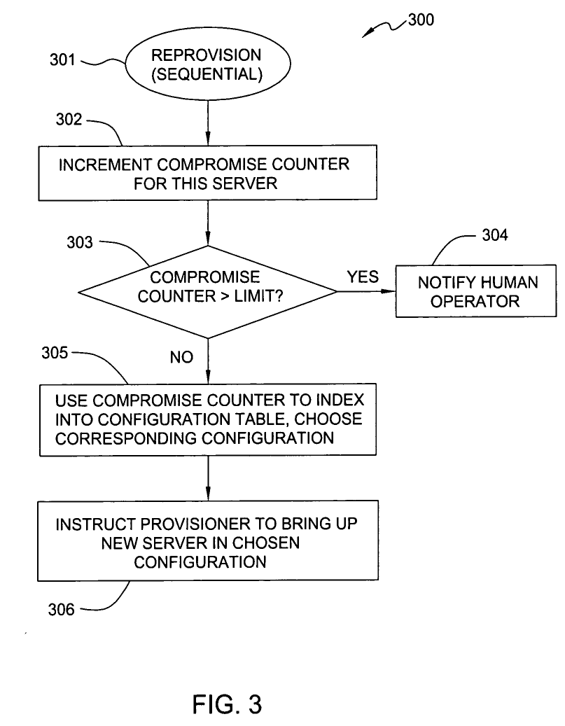

FIG. 3 illustrates a method 300 according to the present invention for utilizing a sequential reprovisioning operation, beginning at block 301. At block 302, a counter corresponding to the server brought down at block 204 is incremented.

At block 303, the counter is compared to a maximum limit, and if it exceeds this limit the operation terminates with a message to a human operator at block 304. If the counter does not exceed the limit at block 303, the counter is then used at block 305 as an index into a table of possible configurations, and the corresponding configuration is selected. At block 306, the provisioner 104 is instructed to bring up a new server 102, configured according to the configuration selected at block 305.

In other embodiments according to the present invention, the configuration used to bring up a new server may be generated on the fly rather than being selected from a table of fixed configurations. In still other embodiments according to the present invention, the configuration used to bring up the new server may be chosen according to algorithms that take into account the nature of the assault or compromise that was detected, and other security-relevant events, if any, observed in the system as a whole.

It is envisioned that security-relevant events taken into account by these algorithms in embodiments according to the present invention include security assaults detected against other servers on the same or other networks, unusual or suspicious network traffic detected on the same or other networks, and the discovery or disclosure of security vulnerabilities in hardware or software components known to be used in at least some of the servers on the network.

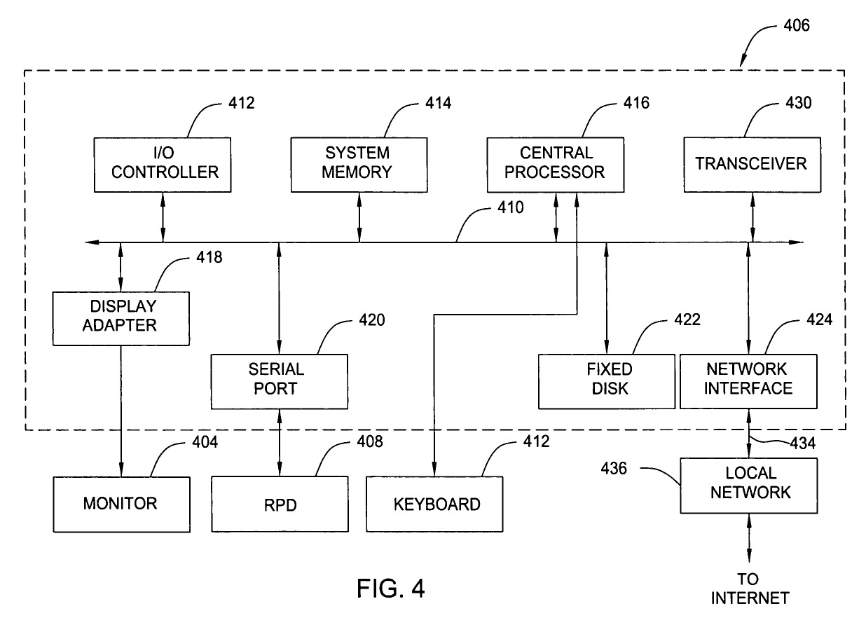

FIG. 4 illustrates subsystems found in one exemplary computer system, such as computer system 406, which can be used in accordance with embodiments according to the present invention. Computers can be configured with many different hardware components and can be made in many dimensions and styles (e.g., laptop, palmtop, server, workstation and mainframe). Thus, any hardware platform suitable for performing the processing described herein is suitable for use with the present invention.

Subsystems within computer system 406 are directly interfaced to an internal bus 410. The subsystems include an input/output (I/O) controller 412, a system random access memory (RAM) 414, a central processing unit (CPU) 416, a display adapter 418, a serial port 420, a fixed disk 422 and a network interface adapter 424. The use of bus 410 allows each of the subsystems to transfer data among the subsystems and, most importantly, with CPU 416. External devices can communicate with CPU 416 or other subsystems via bus 410 by interfacing with a subsystem on bus 410. Various devices can be coupled to computer system 406, for example, a monitor 404, a remote programming device (RPD) 408 and a keyboard 411.

FIG. 4 is merely illustrative of one suitable configuration for providing a system in accordance with the present invention. Subsystems, components or devices other than those shown in FIG. 4 can be added without deviating from the scope of the invention. A suitable computer system can also be achieved without using all of the subsystems shown in FIG. 4. Other subsystems such as a CD-ROM drive, graphics accelerator, etc., can be included in the configuration without affecting the performance of computer system 406.

One embodiment according to the present invention is related to the use of an apparatus, such as computer system 406, for implementing a system according to embodiments of the present invention. CPU 416 can execute one or more sequences of one or more instructions contained in system RAM 414. Such instructions may be read into system RAM 414 from a computer-readable medium, such as fixed disk 422. Execution of the sequences of instructions contained in system RAM 414 causes the CPU 416 to perform process blocks, such as the process blocks described herein. One or more processors in a multi-processing arrangement may also be employed to execute the sequences of instructions contained in the memory. In alternative embodiments, hard-wired circuitry may be used in place of or in combination with software instructions to implement the invention. Thus, embodiments of the invention are not limited to any specific combination of hardware circuitry and software.

The terms “computer-readable medium” and “computer-readable media” as used herein refer to any medium or media that participate in providing instructions to CPU 416 for execution. Such media can take many forms, including, but not limited to, non-volatile media, volatile media and transmission media. Non-volatile media include, for example, optical or magnetic disks, such as fixed disk 422. Volatile media include dynamic memory, such as system RAM 414. Transmission media include coaxial cables, copper wire and fiber optics, among others, including the wires that comprise one embodiment of bus 410. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, punch cards, paper tape, any other physical medium with patterns of marks or holes, a RAM, a PROM, an EPROM, a FLASHEPROM, any other memory chip or cartridge, a carrier wave, or any other medium from which a computer can read.

Various forms of computer-readable media may be involved in carrying one or more sequences of one or more instructions to CPU 416 for execution. Bus 410 carries the data to system RAM 414, from which CPU 416 retrieves and executes the instructions. The instructions received by system RAM 414 can optionally be stored on fixed disk 422 either before or after execution by CPU 416.

While the foregoing is directed to the illustrative embodiment of the present invention, other and further embodiments of the invention may be devised without departing from the basic scope thereof, and the scope thereof is determined by the claims that follow.

1. A method for automated adaptive reprovisioning of servers under security assault, the method comprising:
detecting a security assault or a possible security assault on a first server; and
reprovisioning by automatically creating a new server instance with a desired new server configuration to perform at least one of the tasks performed by said first server.

2. The method of claim 1, wherein said detecting comprises determining if said first server is a candidate for reprovisioning, because of properties or behavior that suggest its security has been compromised or is likely to be compromised, or its functioning otherwise unacceptably impaired, by a security assault.

3. The method of claim 1, wherein said reprovisioning comprises automatically bringing up said new server instance, or otherwise making available said new server instance to customers or other users of said first server.

4. The method of claim 1, further comprising bringing down said first server prior to said reprovisioning.

5. The method of claim 1, wherein said new server instance brought up in said reprovisioning differs from said first server in at least one parameter.

6. The method of claim 1, wherein a difference between said new server instance and said first server is responsive to whether or not other security incidents have been detected in a network to which said servers are coupled.

7. The method of claim 1, wherein a difference between said new server instance and said first server is responsive to a nature of any other security incidents that have been detected in said network to which said servers are coupled.

8. The method of claim 1, wherein a difference between said new server instance and said first server is responsive to a probable compromise or a functional impairment observed in said detection.

9. The method of claim 1, wherein a difference between said new server instance and said first server includes a version of server software used by said servers.

10. The method of claim 1, wherein a difference between said new server instance and said first server includes a version of operating system software used by said servers.

11. The method of claim 1, wherein a difference between said new server instance and said first server includes a version of network connectivity software used by said servers.

12. The method of claim 1, wherein a difference between said new server instance and said first server includes strength of encryption used by said servers.

13. The method of claim 1, wherein a difference between said new server instance and said first server includes a degree of function offered to users by said servers.

14. The method of claim 1, wherein said new server instance brought up in said reprovisioning differs from said first server only if more than a fixed number of instances of probable server compromise have been observed.

15. The method of claim 1, wherein a difference between said new server instance and said first server is responsive to a number of probable server compromises that have been observed.

16. The method of claim 1, wherein said server comprises a computer providing services through a network.

17. The method of claim 1, wherein said server comprises a program running on a network-coupled computer, providing services through a network.

18. The method of claim 1, wherein said reprovisioning comprises selecting said desired new server configuration for said new server instance from a plurality of new server configurations.

19. The method of claim 18, wherein said selecting said desired new server configuration for said new server instance comprises selecting a new server configuration from a table of new server configurations.

20. The method of claim 18, wherein said selecting said desired new server configuration for said new server instance comprises randomly selecting a new server configuration from among all new server configurations in a table.

21. The method of claim 18, wherein said selecting said desired new server configuration for said new server instance comprises randomly selecting a new server configuration from among all new server configurations in a table for which no probable compromise has been observed.

22. The method of claim 18, wherein said selecting said desired new server configuration for said new server instance comprises indexing into a table according to a number of times a server providing a function of said first server has been subject to probable compromise.

23. A computer-readable medium having stored thereon a plurality of instructions for automated adaptive reprovisioning of servers under security assault, said plurality of instructions including instructions which, when executed by a processor, cause said processor to perform:
detecting a security assault or a possible security assault on a first server; and
reprovisioning by automatically creating a new server instance with a desired new server configuration to perform at least one of the tasks performed by said first server.

24. The computer-readable medium of claim 23, wherein said detecting comprises determining if said first server is a candidate for reprovisioning, because of properties or behavior that suggest its security has been compromised or is likely to be compromised, or its functioning otherwise unacceptably impaired, by a security assault.

25. The computer-readable medium of claim 23, wherein said reprovisioning comprises automatically bringing up said new server instance, or otherwise making available said new server instance to customers or other users of said first server.

26. The computer-readable medium of claim 23, further comprising bringing down said first server prior to said reprovisioning.

27. The computer-readable medium of claim 23, wherein said new server instance brought up in said reprovisioning differs from said first server in at least one parameter.

28. The computer-readable medium of claim 23, wherein a difference between said new server instance and said first server is responsive to whether or not other security incidents have been detected in a network to which said servers are coupled.

29. The computer-readable medium of claim 23, wherein a difference between said new server instance and said first server is responsive to a nature of any other security incidents that have been detected in said network to which said servers are coupled.

30. A system for automated adaptive reprovisioning of servers under security assault, the system comprising:
a first server;
a security monitor, coupled to said first server, for detecting if said first server is a candidate for automatic reprovisioning with a new server instance; and
a provisioner, coupled to said first server, for automatically reprovisioning said server with said new server instance if said server is such a candidate.
